(19) United States
(12) Patent Application Publication
(10) Pub. No.: US 2008/0163701 A1
(43) Pub. Date: Jul. 10, 2008

(54) Method and Device for the Taking and Analysis of Samples

(76) Inventors: Michael Ukelis, Riedstadt (DE); Bertram Cezanne, Moerfelden-Walldorf (DE); Hanns Wurziger, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/813,477

(22) PCT Filed: Dec. 16, 2005
(86) PCT No.: PCT/EP2005/013595

§ 371 Date: Jul. 6, 2007

(30) Foreign Application Priority Data
Jan. 7, 2005 (DE) 102005001015.6
Jul. 23, 2005 (DE) 102005034574.3

(51) Int. Cl. G01N 1/20

(52) U.S. Cl. 73/863.81

(57) ABSTRACT

In a method for the taking and analysis of samples from a microreaction system (3) having a suction line (9) arranged laterally alongside a discharge aperture (4) of the microreaction system (3), a reduced pressure is generated in the suction line (9) for the aspiration of substances exiting from the discharge aperture (4), causing the exiting substance stream to be divided into an aspirated substance stream and a free-falling substance stream, and one of the two divided substance streams is subsequently fed to an analytical device (10) for analysis. The reduced pressure in the suction line (9) can be influenced and thus the division of the exiting substance stream can be controlled as a function of a result of the analysis. Reaction parameters can also be pre-specified or controlled as a function of analytical results. A device for carrying out the method has an opening of the suction line (9) which is arranged laterally alongside the discharge aperture (4), where a reduced pressure can be generated in the suction line (9), and an analytical device (10) is either connected to the suction line (9) or arranged below the discharge aperture (4).

The invention relates to a method for the taking and analysis of samples from a microreaction system.

With increasing miniaturisation of individual microreactors and the elements used in a microreaction system and continuously improved accuracy and sensitivity of various analytical methods, ever-smaller amounts of substance can be used for carrying out series of experiments or in the preparation of reagents. Whereas amounts of sample in the order of millilitres or more were necessary in the past in order reliably to carry out and evaluate reactions, amounts of sample in the region of microlitres or even nanolitres can be used or processed today. In this way, the effort and costs both with respect to the requisite amounts of substance and also the requisite reaction times can be reduced. The thermal process management is simplified by the reduced mass flows, and a hazard and any existing environmental pollution during and after the reaction are reduced.

Both when carrying out extended series of experiments and also in the control of established reaction processes, it is frequently necessary to take small amounts of sample from a continuously operated microreaction system without hindering or terminating the flow of the reagents through the microreaction system or even a proceeding chemical reaction. For the taking of the amounts of sample necessary for this purpose, a discharge aperture is usually provided which is arranged at a suitable point within the microreaction system and can be controlled via a valve or closure. Cavities unavoidably form here, in which the chemical reaction proceeding in the microreaction system does not take place or takes place under different, usually uncontrollable reaction conditions. In this way, both the course of the reaction or the resultant reaction product and also the composition of an amount of sample recommended for analysis can be influenced and impaired in an undesired manner, meaning that it may not be possible to utilise a considerable part of the reaction product or analyses.

On use of the same microreaction systems for different substances and reaction processes, complex cleaning of the elements which come into contact with the substances must be carried out every time. This cleaning is made more difficult by the presence of dead spaces in cavities and by closure elements or valves.

Devices for the taking of small amounts of sample are known (U.S. Pat. No. 6,074,880) in which a substance stream is passed through a channel. The channel has one or more openings, for example in the form of a through-hole, so that a small amount of sample can be blown out of the substance stream flowing through the channel through an opening provided for this purpose in the channel by puffs of compressed air directed onto the channel.

It is also known (U.S. Pat. No. 3,974,697) to influence the flow direction of a substance stream transported in a branched channel system by generating suitable pressure differences in such a way that the substance stream flows into the desired channel branch.

The known devices enable small amounts of substance to be sampled, but require not inconsiderable design complexity.

Immediate analysis of the amount of sample taken is not provided in the case of the known devices.

The object of the invention is accordingly to design a method for the taking and analysis of samples in such a way that sampling with the least possible impairment of the proceeding microreaction and immediately subsequent analysis of the amount of sample taken are possible.

This object is achieved in accordance with the invention by a method for the taking and analysis of samples from a microreaction system and a suction line arranged laterally alongside a discharge aperture of the microreaction system, where a reduced pressure is generated in the suction line for the aspiration of substances exiting from the discharge aperture, causing the exiting substance stream to be divided into an aspirated substance stream and a free-falling substance stream, and where one of the two divided substance streams is subsequently fed to an analytical device for analysis. The discharge aperture here is either used as microreaction system outlet for complete discharge of the substances involved in the chemical reaction or is designed to be sufficiently small and is arranged at a suitable point within the microreaction system so that an amount of substance exiting continuously at the discharge aperture does not significantly impair the reaction proceeding further in the microreaction system. Neither valves, closures nor devices generating compressed air are necessary in order to take a desired amount of sample.

One of the two divided substance streams, namely either the substance stream aspirated into the suction line or the non-aspirated, free-falling substance stream, is fed directly to an analytical device and allows rapid, substantially undistorted analysis of the substances which have exited from the discharge aperture.

Either due to the design or depending on the further use desired in each case for the exiting substances, it can be freely selected here whether, for example, the aspirated substance stream is used exclusively for analytical purposes and subsequently discharged and disposed of and the non-aspirated, free-falling substance stream is intended for packaging in one or more containers. It is likewise possible for the aspirated substance stream to be fed directly to further processing and analysis and control of the exiting substances to be carried out by an analytical device which collects and evaluates the free-falling sub-stance stream below the discharge aperture.

It is preferably provided that the reduced pressure in the suction line and thus the division of the exiting substance stream is influenced as a function of a result of the analysis. Thus, continuous aspiration and analysis of the exiting substance stream could firstly be carried out until, for example, a desired concentration of a reaction product becomes established, and the exiting substance stream is subsequently utilised in a suitable manner and samples are merely taken at suitable intervals for analytical purposes and for control.

It is particularly advantageously provided that the division of the exiting substance stream is controlled as a function of analytical results. In this way, extended series of experiments can be carried out in a substantially automated manner. The exiting substance stream is analysed at intervals or substantially continuously. As soon as or as long as the analytical results are in a prespecifiable range, the exiting substance stream can be delivered, for example, into a collecting container or used as starting material for a further reaction.

It is likewise advantageous and conceivable that the further use of the exiting substance stream is controlled as a function of results of the analysis. In particular in the case of non-contact analyses or in the case of analyses which do not adversely affect the reaction substances, a decision can in this way be made on the further use both of the aspirated substance stream and also of the free-falling substance stream depending on the analytical results and thus the composition of the analysed substance stream, and a corresponding control can take place.

It is preferably provided that one or more reaction parameters are controlled as a function of the results of the analysis. In this way, long series of experiments with a prespecifiable reaction of reaction parameters can be carried out in a controlled and automated manner. It is likewise possible to modify the proceeding reaction or the resultant reaction products by variation of the reaction parameters until analysis of the exiting substance stream shows that a desired composition or property of the exiting substance stream has been achieved. In this case, it is advantageous, through suitable control of the division of the exiting substance stream, for samples to be taken, packaged and optionally stored for documentation purposes or for further evaluation or investigation.

Instead of substantial automation of series of experiments, the method described can also be used for comprehensive monitoring of a known or prespecified reaction course and the resultant reaction products. If, for example, the exiting substance stream is to be distributed over a large number of containers and only a very small amount of substances is to be packaged in each container, for example in a microcavity, the method described can be used to carry out an analysis of the exiting substance stream between each of the individual packaging operations and to measure and monitor the properties or quality thereof.

The invention also relates to a device for carrying out the method described, having a microreaction system with a discharge aperture for substances involved in the reaction.

In accordance with the invention, an opening of a suction line is arranged laterally alongside the discharge aperture, where a reduced pressure can be generated in the suction line for aspiration of the substances exiting from the discharge aperture, and an analytical device is either connected to the suction line or arranged below the discharge aperture. The discharge aperture can be designed in such a way that no or only an insignificant dead space in the form of cavities, in which no reaction takes place or a reaction can only take place under different, possibly uncontrollable conditions, becomes necessary due to the discharge aperture. The sampling system design according to the invention ensures that the amount of sample fed to the analytical device does not differ in composition from the substances involved in the microreaction, or only does so to an insignificant extent. In this way, high significance of the measurements and evaluations carried out in the analytical device is ensured. In particular if the discharge aperture is simultaneously also the exit from the microreaction system and the substance stream exiting from the discharge aperture is identical with the reaction products, impairment or distortion of the reaction proceeding in the microreaction system is substantially excluded.

It is preferably provided that the analytical device is connected to a control device for controlling the reduced pressure in the suction line. In this way, it can be specified using simple means, depending on the results of the analysis, whether the substance stream exiting from the discharge aperture is aspirated owing to a reduced pressure generated in the suction line or alternatively is not aspirated and is intended to fall freely downwards owing to gravity.

It is advantageously provided that the control device is a valve. The control of the reduced pressure in the suction line by means of a valve is possible using comparatively little design complexity and allows rapid pressure changes and thus precise control during division of the exiting substance stream.

According to an advantageous embodiment of the inventive idea, it is proposed that the analytical device and subsequently the control device are arranged along the suction line. This prevents undesired contamination of the reaction products present in the substance stream due to unavoidable dead spaces in the valve or due to the uptake of valve materials, etc., and thus a distortion of the measurement results.

It is likewise conceivable that the control device and subsequently the analytical device are arranged along the suction line. In this way, the reaction time with which control commands from the analytical device are able to act on the division of the substance stream can be improved. An arrangement of this type can be employed particularly advantageously if precise metering of the divided substance streams is more important than the avoidance of possibly insignificant contamination.

It is preferably provided that a casing having an outlet opening for substances exiting from the discharge aperture and having a passage opening for the suction line is arranged around the discharge aperture. The casing on the one hand protects the region around the discharge aperture against undesired, uncontrollable environmental influences and on the other hand allows precise and reproducible arrangement of the suction line relative to the discharge aperture using simple means. The closer the opening of the suction line can be arranged relative to the discharge aperture without the exiting substance stream coming into direct contact with the suction line, the lower the minimum necessary reduced pressure within the suction line in order to guarantee complete aspiration of the amount of substance exiting from the discharge aperture.

According to an embodiment of the inventive idea, it is proposed that the arrangement of the opening of the suction line relative to the discharge aperture can be modified. In this way, at a prespecified reduced pressure in the suction liner the suction action caused thereby in the region of the discharge aperture can be modified in order to take into account possibly different properties of the substances and reaction products used for example different viscosities or volatilities.

According to an advantageous embodiment of the inventive idea, it is proposed that the discharge aperture is designed in the form of a capillary. A capillary facilitates on the one hand precise metering even and in particular of relatively small amounts of substance during discharge from the microreaction system and on the other hand substantially prevents the reactions proceeding in the microreaction system from being influenced by the changing pressure conditions in the immediate vicinity of the discharge aperture. The internal diameter of the capillary is advantageously chosen to be sufficiently small here in order to guarantee complete aspiration of the exiting amounts of substance and on the other hand should be chosen to be sufficiently large in order to avoid endangering continuous discharge of the substances due to a sharply increasing differential pressure in the capillary. With a suitable capillary, it can be ensured, in particular, that the substance stream exits from the discharge aperture in a fine, free jet.

It is advantageously provided that a region around the discharge aperture is heatable. It has been found that, on use of readily volatile solvents, such as, for example, dichloromethane or ether, ice formation at the discharge aperture may occur owing to the enthalpy of evaporation of the solvent. This undesired impairment during operation can be readily avoided by warming in the region of the discharge aperture.

According to an embodiment of the inventive idea, it is proposed that a protective-gas atmosphere which displaces the atmospheric humidity can be produced and maintained in a region around the discharge aperture. The protective-gas atmosphere can be used instead of or in addition to a heating device in order to prevent undesired ice formation at a discharge aperture which is cooling. In addition, it is possible by means of a protective-gas atmosphere substantially to prevent contamination of the substance streams exiting from the discharge aperture.

An illustrative embodiment of the invention is described in greater detail below and is depicted in the drawing, in which:

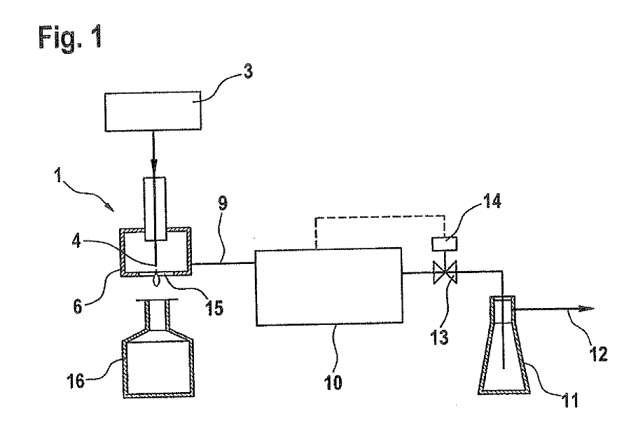

FIG. 1 shows a diagrammatic general view of a device for the taking and analysis of samples from a microreaction system,

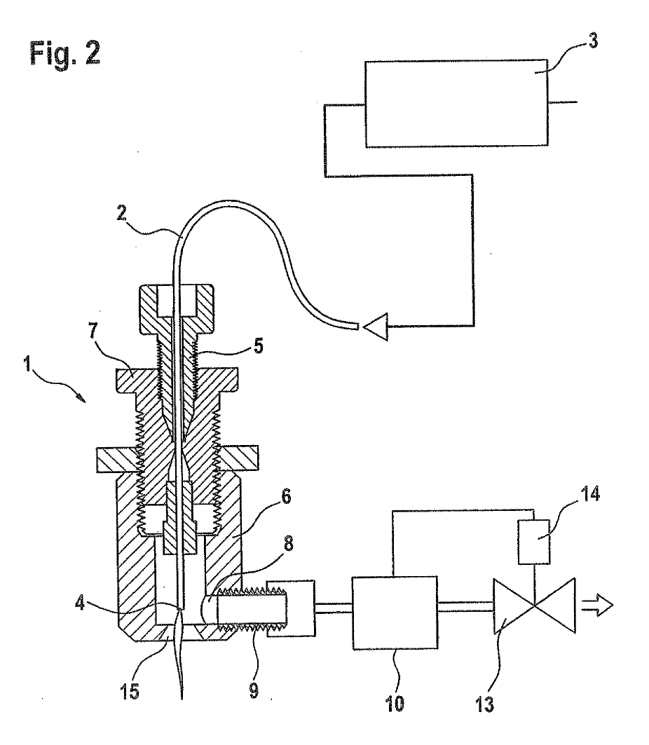

FIG. 2 shows a detailed representation of a sampling device to which an analytical device is connected, and

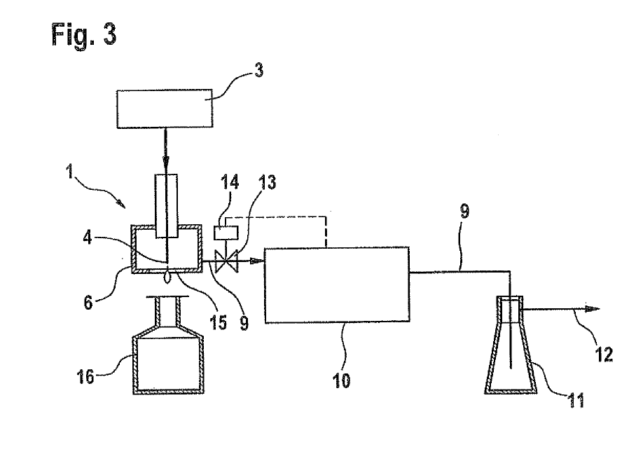

FIG. 3 shows a diagrammatic general view of a device according to FIGS. 1 and 2 having a different arrangement of a magnetic valve for controlling the division of the sample taken.

A sampling device 1 represented in FIGS. 1 and 2 is connected via a hose 2 to a microreaction system 3, which is indicated diagrammatically for simplification and may have a complex design, depending on the specific application. When the reaction is complete, the entire microreaction system 3 is completely emptied via the sampling device 1. The discharge aperture 4 is designed in the form of a capillary. The hose 2 is detachably connected to the discharge aperture 4 or the capillary via connector 5. In this way, a plurality of microreaction systems 3 with different sampling devices 1 can be used in any desired combination, so that, for example, associated sampling devices 1 can in each case be combined with a microreaction system 3 which is suitable for certain applications depending on substances used. A microreaction system 3 to be cleaned or a sampling device 1 to be cleaned can also be exchanged simply, so that virtually continuous operation is guaranteed.

The discharge aperture 4 designed as a capillary is arranged movably in the interior of a sleeve-shaped casing 6. Both the connector 5 of the hose 2 and the discharge aperture 4 in capillary form are attached in a casing lid 7 which engages with the casing 6 via a screw thread and thus facilitates longitudinal movement of the open end of the capillary relative to the base of the casing 6.

The casing 6 has, adjacent to the capillary-form discharge aperture 4, a passage opening 8, through which a suction line 9 projects into the interior of the casing 6. The suction line 9 runs into an analytical device 10. A substance stream fed to the analytical device 10 via the suction line 9 can be subjected to suitable measurements in the analytical device 10, the evaluation of which allows conclusions to be drawn on the properties, for example the composition or concentration, of individual reaction products in the substance stream. After the analysis, the substance stream is fed from the analytical device 10 into a wash bottle 11, which is connected to a vacuum line 12.

In the suction line 9, a magnetic valve 13, by means of which the reduced pressure which can be generated in the suction line 9 can be controlled, is arranged downstream of the analytical device 10. The magnetic valve 13 is connected via a control device 14 to the analytical device 10 and is controllable thereby. Depending on the results of an analysis, the magnetic valve 13 can be opened or closed and the reduced pressure prevailing in the suction line 9 can thus be specified.

For the taking and analysis of a sample of the reaction products, the magnetic valve 13 is opened and a reduced pressure is generated in the suction line 9. The reduced pressure causes the substance stream exiting from the discharge aperture 4 to be sucked into the suction line 9 and fed to the analytical device 10. If it is determined as a result of the analyses that the analysed sample meets specified criteria, the magnetic valve 13 can be closed and the then free-falling substance stream can exit through an outlet opening 15 in the base of the casing 6 and can be collected in a suitable sample container 16.

The amount of substance aspirated into the suction line 9 or exiting through the outlet opening 15 can be metered precisely via the duration of the switched-on or switched-off vacuum or the reduced pressure generated, so that use of the sampling device 1 as metering system in the case of analyses and controls which are carried out at regular intervals is also conceivable.

Due to the arrangement of the magnetic valve 13 downstream of the analytical device 10, any contamination of the samples taken and intended for analysis is avoided. If the most accurate possible metering and division of the sub-stance stream exiting from the discharge aperture 4 is of importance instead of the avoidance of possible contamination, the magnetic valve 13 can be arranged upstream of the analytical device 10 in the suction line 9, as shown in FIG. 3. In this illustrative embodiment, the reaction time for control of the division of the exiting substance stream is shorter than in the illustrative embodiment according to FIGS. 1 and 2 since a change in the pressure or a build-up of vacuum above the dead space of the analytical device 10 is not necessary.

Inside the casing 6, local heating in the region around the discharge aperture 4, for example through the use of an electrical heating device or heat coupling, can be achieved in a simple manner. Controlled feed of a preferably chemically substantially inactive protective gas into the casing 6 can also prevent a reaction, albeit only brief, of the exiting substance stream with the ambient air distorting the measurement values obtained in the analytical device 10 or adversely affecting the reaction products produced before any further use intended.

1. Method for the taking and analysis of samples from a microreaction system (3) having a suction line (9) arranged laterally alongside a discharge aperture (4) of the microreaction system (3), where a reduced pressure is generated in the suction line (9) for the aspiration of substances exiting from the discharge aperture (4), causing the exiting substance stream to be divided into an aspirated substance stream and a free-falling substance stream, and where one of the two divided substance streams is subsequently fed to an analytical device (10) for analysis.

2. Method according to claim 1, characterised in that the reduced pressure in the suction line (9) and thus the division of the exiting substance stream is influenced as a function of the result of the analysis.

3. Method according to claim 2, characterised in that the division of the exiting substance stream is controlled as a function of analytical results.

4. Method according to claim 1, characterised in that the further use of the exiting substance stream is controlled as a function of results of the analysis.

5. Method according to claim 1, characterised in that one or more reaction parameters are controlled as a function of results of the analysis.

6. Device for carrying out the method according to claim 1, having a microreaction system (3) with a discharge aperture (4) for substances involved in the reaction, characterised in that an opening of a suction line (9) is arranged laterally alongside the discharge aperture (4), where a reduced pressure can be generated in the suction line (9) for aspiration of the substances exiting from the discharge aperture (4), and in that an analytical device (10) is either connected to the suction line (9) or arranged below the discharge aperture (4).

7. Device according to claim 6, characterised in that the analytical device (10) is connected to a control device for controlling the reduced pressure in the suction line (9).

8. Device according to claim 7, characterised in that the control device is a valve (13).

9. Device according to claim 6, characterised in that the analytical device (10) and subsequently the control device are arranged along the suction line (9).

10. Device according to claim 6, characterised in that the control device and subsequently the analytical device (10) are arranged along the suction line (9).

11. Device according to claim 6, characterised in that a casing (6) having an outlet opening (15) for substances exiting from the discharge aperture (4) and having a passage opening (8) for the suction line (9) is arranged around the discharge aperture (4).

12. Device according to claim 6, characterised in that the arrangement of the opening of the suction line (9) relative to the discharge aperture (4) can be modified.

13. Device according to claim 6, characterised in that the discharge aperture (4) is designed in the form of a capillary.

14. Device according to claim 6, characterised in that a region around the discharge aperture (4) is heatable.

15. Device according to claim 6, characterised in that a protective-gas atmosphere which displaces the atmospheric humidity can be produced and maintained in a region around the discharge aperture (4).
